(19) United States
(12) Patent Application Publication
(10) Pub. No.: US 2002/0160126 A1
(43) Pub. Date: Oct. 31, 2002

(54) Liquid-crystal optical controller and a method of manufacturing the same

(76) Inventors: Yasuo Toko, Yokohama-shi (JP); Kiyoshi Ando, Yokohama-shi (JP); Yoshihisa Iwamoto, Yokohama-shi (JP); Kazuki Takeshima, Yokohama-shi (JP)

Correspondence Address: FRISHAUF, HOLTZ, GOODMAN,, LANGER & CHICK, P.C., 767 Third Avenue - 25th Floor, New York, NY, 10017-2023, US

(21) Appl. No.: 09/725,374

(22) Filed: Nov. 29, 2000

(30) Foreign Application Priority Data
Feb. 10, 2000 (JP) 2000-033941

(51) Int. Cl. G02F 1/133; C09K 19/02

(52) U.S. Cl. 428/1.1

(57) ABSTRACT

The steps of forming electrodes on one surface of a first substrate, forming electrodes on one surface of a second substrate, said second substrate opposing to said first substrate; preparing a phase boundary of the first substrate, the phase boundary allowing liquid-crystal molecules to align parallel to said substrate; preparing a phase boundary of the second substrate, the phase boundary allowing liquid-crystal molecules to align vertical to said substrate; filling a gap between said first and second substrates with liquid crystal to which a polymerizable material is added; and polymerizing the material added to the liquid crystal are employed. Even when a liquid-crystal cell is relatively thick, a high-speed operation can be achieved, and its response speed is rarely lowered in operation for an intermediate gradation, and the effective aperture ratio is increased.

This application is based on Japanese Patent Application, 2000-033941, filed on Feb. 10, 2000, all the content of which is incorporated in this application by reference.

### BACKGROUND OF THE INVENTION

1. Field of the Invention

The present invention relates to a liquid-crystal optical controller and a manufacturing method thereof, and in particular, to a liquid-crystal optical controller and a manufacturing method thereof using cells of liquid crystal of hybrid aligned nematic (HAN) type in which molecules of liquid crystal are aligned vertical to one of surfaces of a substrate and are aligned parallel to one of surfaces of another substrate.

2. Description of the Related Art

A liquid-crystal optical controller controls, like a liquid-crystal shutter or a liquid-crystal lens, light by using electrooptical characteristics of liquid crystal. Such a shutter is employed as an optical shutter or as an iris of a camera and a printer, and such a liquid-crystal lens is employed to control a focal point or an optical axis of an optical pickup device and an optical read/write head of a digital versatile disk (DVD) unit, a compact disk (CD) unit, and the like.

When no voltage is applied to a liquid-crystal cell of HAN type, the liquid-crystal molecules are in a state ranging from a homeotropic alignment to a homogeneous alignment. In the homeotropic alignment, the molecules are aligned vertical to a substrate surface. In the homogeneous alignment, the molecules are aligned parallel to the substrate surface. In the state, the liquid-crystal molecules are aligned in a direction which continuously turned by 90° from one surface of a first substrate to one opposing surface of a second substrate with respect to normal of the surfaces of the substrates.

Heretofore, a twist nematic (TN) mode, an STN mode, and a ferroelectric liquid-crystal (FLC) mode have been proposed for liquid-crystal cells of a high-speed shutter. In an optical pickup device of a compact disk unit or a digital versatile disk unit, a liquid-crystal lens is used to control focal length by changing a diffraction index of the liquid crystal, for example, to correct a focal point of the optical pickup device. The state of alignment of liquid crystal is changed by a voltage applied thereto. This results in a change of the diffraction index of a layer of liquid crystal, and hence its focal length is changed.

To obtain a high-speed response in a liquid-crystal cell of the TN or STN mode, it is necessary to reduce thickness of the cell. When the cell thickness is about two micrometers (μm), a response time of about one millisecond (ms) is obtained. To stabilize a state of surfaces of liquid-crystal cells in the FLC mode, the cells are required to have a thickness of about 2 μm or less. Production of such a thin liquid-crystal cell requires a clean room of quite a high degree of cleanness. This soars the liquid-crystal production cost. If such a high-quality clean room is not available, dirt causes many gap defects and production yield is lowered.

For liquid-crystal cells in the TN or STN mode, a rising speed can be increased by reducing the cell thickness and/or by applying a high voltage thereto. However, it is not easy to obtain a higher rising speed, namely, there exists a limit of rising speed. The limit basically depends on properties or characteristics of material of the liquid crystal. The TN and STN modes have been attended with a problem that although a overall on/off operation speed can be increased, the response time is not sufficiently short when the liquid crystal is driven for an intermediate gradation. Particularly, the response characteristic is conspicuously lowered when the liquid crystal is driven for the intermediate gradation by a voltage similar to an off voltage. In a worst case, the response speed is lowered about ten times as compared with that of the complete on/off operation.

In the FLC mode, there has been a problem that although a high-speed response time on the order of microsecond can be obtained, liquid-crystal molecules cannot be uniformly aligned and hence it is impossible or quite difficult to drive the liquid crystal for an intermediate gradation.

In a liquid-crystal lens which controls focal length by changing a diffraction index of the liquid crystal, for example, to correct a focal point of an optical pickup device of a compact disk unit or a digital versatile disk unit, a plurality of electrodes (electrodes of an indium-tin-oxide (ITO) pattern) are provided. By changing voltages applied to the respective electrodes, a diffraction index of liquid crystal corresponding to each electrode is changed. This resultantly controls the focal length of the liquid-crystal cell. In a liquid-crystal lens or shutter, to effectively pass light from a light source, it is required to possibly reduce loss of the light passing therethrough. The liquid-crystal must therefore have a high aperture ratio. To reduce an ineffective area and to increase an effective area, it is desired to possibly minimize distance between adjacent ITO-pattern electrodes. However, the minimization of the distance between the adjacent electrodes results in difficulty in fine patterning, and defects of short circuits easily take place. Although ITO electrodes patterning has a limit of about ten micrometers for good yield, a high-density electrode layout has been desired. Even if such a high density is realized, the aperture ratio is desirably improved without increasing the ineffective area.

### SUMMARY OF THE INVENTION

It is therefore an object of the present invention to provide a liquid-crystal optical controller and a manufacturing method thereof in which a high-speed operation is possible with a relatively thick liquid-crystal cell, the response speed is not decreased even in operation for an intermediate gradation, and the aperture ratio is substantially improved.

According to one aspect of the present invention, there is provided a liquid-crystal optical controller comprising a first substrate, a first electrode formed on one surface of said first substrate, a first alignment film formed on said first substrate to cover said first electrode, the first alignment film having an alignment characteristic of a horizontal or vertical alignment film; a second substrate formed opposing to said first substrate with a predetermined gap therebetween, a second electrode formed on a surface of said second substrate, the surface opposing to said one surface of said first substrate; a second alignment film formed on said second substrate to cover said first electrode, the film having an alignment characteristic opposite to that of said first alignment film; and a large number of liquid-crystal molecules and polymer (mixed with the liquid-crystal molecules) for stabilizing a state of chemical bonds between said liquid-crystal molecules. Said liquid-crystal molecules and said polymer form a liquid-crystal layer sandwiched between said first substrate and said second substrate. Said liquid-crystal layer includes a plurality of regions respectively having different states of chemical bonds between said liquid-crystal molecules.

According to another aspect of the present invention, there is provided a method of producing a liquid-crystal optical controller, comprising the steps of forming electrodes on one surface of a first substrate, forming electrodes on one surface of a second substrate, said second substrate opposing to said first substrate; preparing a phase boundary of the first substrate, the phase boundary allowing liquid-crystal molecules to align parallel to said substrate; preparing a phase boundary of the second substrate, the phase boundary allowing liquid-crystal molecules to align vertical to said substrate; filling a gap between said first and second substrates with liquid crystal to which a polymerizable material is added, and polymerizing the material added to the liquid crystal.

According to a liquid-crystal optical control technique of the present invention, when an HAN-mode liquid crystal cell including liquid crystal to which polymerizable material is added is used and the liquid crystal is polymerized, a relatively thick cell of the liquid crystal can be operated at a high speed and its response speed is rarely decreased in operation for an intermediate gradation, and the effective aperture ratio is increased.

### BRIEF DESCRIPTION OF THE DRAWINGS

The objects and features of the present invention will become more apparent from the consideration of the following detailed description taken in conjunction with the accompanying drawings in which:

FIGS. 1A to 1C are cross-sectional views for explaining a first embodiment of a liquid-crystal optical controller and a manufacturing method thereof according to the present invention;

FIG. 2 is a graph showing a transmittivity-voltage characteristic of the first embodiment of the liquid-crystal optical controller;

FIG. 3 is a graph showing a diffraction-index-voltage characteristic of the first embodiment of the liquid-crystal optical controller;

FIG. 4 is a cross-sectional view showing constitution of a second embodiment of a liquid-crystal optical controller according to the present invention; and

FIG. 5 is a structural formula of mesomorphic di-acrylate monomeric resin.

### DESCRIPTION OF THE PREFERRED EMBODIMENTS

In the HAN mode, a relatively thick liquid-crystal cell can be operated at a high speed and the response is independent of gradation when the cell is operated for an intermediate gradation level. In the first embodiment of the liquid-crystal optical controller and the method of manufacturing the same, a liquid-crystal cell of the HAN mode is employed and liquid crystal of the cell is polymerized for stabilization thereof. This resultantly increases a rising speed in the response of the liquid crystal. An ultraviolet-ray-setting monomer or an ultraviolet-ray-curable liquid crystal is added to the liquid crystal and an ultraviolet ray is irradiated onto the liquid crystal to stabilize the liquid crystal through polymerization. During the irradiation of the ultraviolet ray, voltages are applied to predetermined electrodes of the liquid-crystal cell.

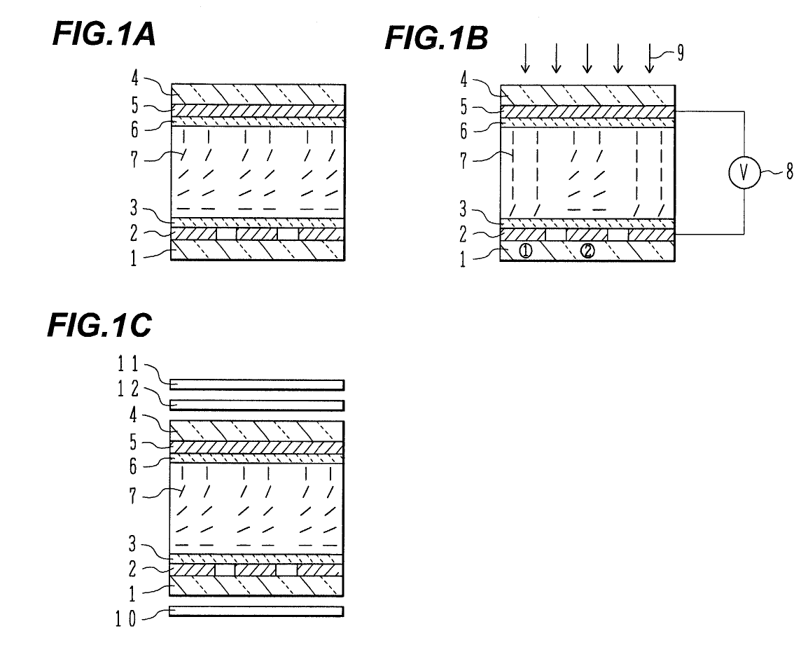

Referring to the drawings, description will be given of the method of manufacturing the first embodiment of the liquid-crystal optical controller. FIG. 1A shows an HAN-mode liquid-crystal cell in a cross-sectional view. First, a plurality of transparent electrodes 2 are formed in a predetermined pattern with indium tin oxide (ITO) on one surface of a substrate (first substrate) 1 and then a horizontal alignment film 3 is formed thereon, and a rubbing process is conducted therefor for alignment. On one surface of another substrate (a second substrate) 4, a transparent (ITO) electrode 5 is formed in a predetermined pattern, and a vertical alignment film 6 is formed thereon. The substrates 1 and 4 are arranged to form an empty cell therebetween with a cell thickness of 4 μm. The transparent electrodes 2 make it possible to subdivide the liquid-crystal cell into a plurality of areas or partitions.

The cell is then filled with liquid-crystal material 7. Molecules of the liquid crystal are schematically indicated by short line segments in the liquid-crystal material 7. Ultraviolet-ray-setting monomer or ultraviolet-ray-curable liquid crystal is added to the material 7. The content of ultraviolet-ray-setting monomer is in a range of 0.1 wt % to 10 wt % and more desirably in a range of 0.5 wt % to 2 wt %. When ultraviolet-ray-curable liquid crystal is used, the content thereof ranges from 0.1 wt % to 50 wt % and more desirably from 0.5 wt % to 2 wt %.

While a predetermined voltage of a voltage source 8 is applied between the upper and lower electrodes of the cell of HAN-mode liquid crystal to which ultraviolet-ray-setting monomer is added (FIG. 1A), an ultraviolet ray 9 is irradiated to the liquid-crystal cell to stabilize the liquid crystal through polymerization as shown in FIG. 1B. Different voltages are respectively applied to areas \mathring{1} and \mathring{2}. While an ultraviolet ray is being irradiated to the cell, the different voltages are applied to the areas \mathring{1} and \mathring{2}. As a result, the areas \mathring{1} and \mathring{2} differ in a degree of polymerization from each other.

The liquid-crystal cell including the liquid crystal thus polymerized for stabilization is sandwiched by polarization plates (first and second polarization plates) 10 and 11. The plates respectively have polarizing axes orthogonal to each other. A phase compensation plate 12 is further arranged to produce a liquid-crystal shutter as shown in FIG. 1C.

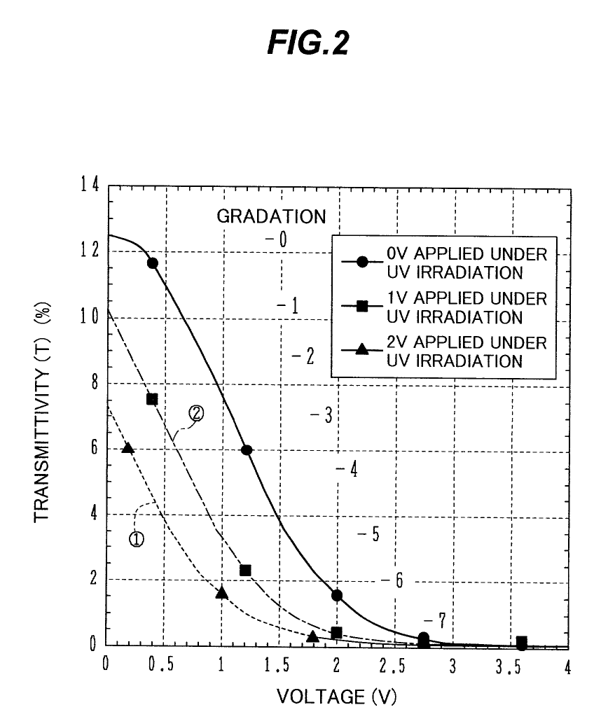

Table 1 shows results of measurement of a response characteristic of the liquid-crystal shutter and FIG. 2 shows a graph of a characteristic of transmittivity (T) with respect to voltage (V) measured using the liquid-crystal shutter. In Table 1, “rise” indicates a change from a state in which no voltage or a low voltage is applied to the liquid-crystal cell to a state in which a high voltage is applied thereto. “Fall” indicates a change reverse to that of “rise”. The change has eight gradation levels including level 0 to level 7, and a change is expressed as 0→1, 6→7, etc. For example, 0→1 indicates that the state changes from gradation level 0 to gradation level 1. “Without polymerization” indicates that the pertinent liquid crystal is not polymerized. For comparison, data measured using an ordinary TN-type liquid crystal is also included in Table 1. To obtain data of the transmittivity-voltage characteristic of FIG. 2, measurement is conducted for an area applied with 0 V (no voltage) and areas respectively applied with 1 V and 2 V while an ultraviolet ray is being irradiated to the liquid-crystal cell. That is, the liquid-crystal cell includes a plurality of regions or partitions of liquid crystal layers having different degrees of polymerization. These partitions of liquid crystal layers are favorably configured to be substantially vertical to the surfaces of the substrates 1 and 4.

As can be seen from Table 1, the rising characteristic is substantially kept unchanged between the region polymerized by the ultraviolet ray and the region not polymerized by the ultraviolet ray. The falling characteristic, i.e., the falling speed in the region polymerized by the ultraviolet ray is about two times that in the region not polymerized by the ultraviolet ray. Even in the operation for intermediate gradation, the falling speed is almost the same as the rising speed, and hence the liquid-crystal cell can be driven at a high speed under any conditions in the region polymerized by the ultraviolet ray.

The transmittivity-voltage characteristic shown in FIG. 2 tells that according to the voltage applied to a region of the liquid-crystal cell under the ultraviolet irradiation, the transmittivity (diffraction index in the cell) can be controlled. Namely, the transmittivity of a region can be controlled by a voltage applied to the pertinent region in the cell driving operation. The response of the cell to the applied voltage is also improved by increasing the content of monomer in the liquid crystal. Therefore, it can be considered that the transmittivity-voltage characteristic is controlled according to the content of monomer in the liquid crystal. In short, the degree of polymerization influences a state of stabilization of polymer and hence influences the transmittivity of the liquid-crystal cell. As indicated by the characteristic curves of FIG. 2, a satisfactory light shielding characteristic is obtained for “black” in the display. Accordingly, in the embodiment of a liquid-crystal optical controlling device, there is provided a liquid-crystal shutter in which a sufficiently high-speed response characteristic is obtained in the rising and falling stages and a satisfactory light shielding characteristic is obtained also in the off state of the cell.

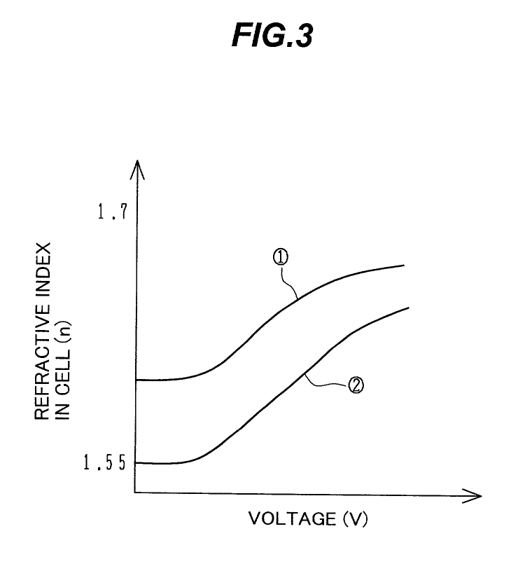

FIG. 3 is a graph of a relationship between a refractive index n in a liquid-crystal cell of the first embodiment and a voltage applied to the cell, particularly, in the areas \mathring{1} and \mathring{2} shown in FIG. 1A. As indicated by the graph, the higher the applied voltage under the ultraviolet ray irradiation is, the higher the refractive index in the cell is. Even if the applied voltage is increased, the relationship is not changed. This implies that the refractive index in the cell becomes higher by the polymerization for stabilization. This is because of the following reason. As shown in FIG. 1B, it can be considered that the refractive index in a direction of the long axis of liquid-crystal molecules is more dominant in the area \mathring{1} than in the area \mathring{2}.

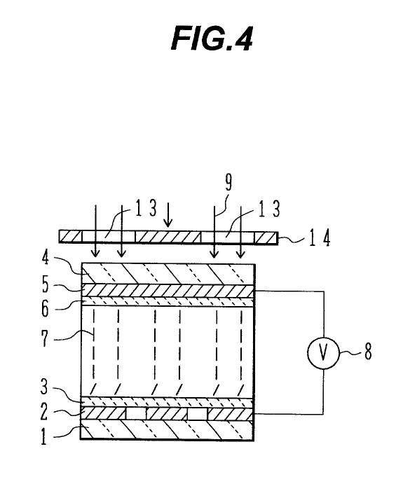

Referring now to FIG. 4, description will be given of the second embodiment of a liquid-crystal optical control device and the method of manufacturing the device. In the manufacturing method, after the process shown in FIG. 1A, a polymerizing and stabilizing process is conducted in place of the process of FIG. 1B. In the process, a photomask 14 having a pattern of predetermined openings 13 are placed over the liquid-crystal cell and an ultraviolet ray is irradiated through the pattern 13 onto the liquid-crystal cell. The other processing steps are the same as those described in conjunction with the first embodiment. Thanks to use of the photomask 14, alignment of liquid-crystal molecules can be controlled. In respective regions of the liquid-crystal cell, the molecules can be differently aligned in a direction of thickness of the cell.

By appropriately setting positions and sizes of respective openings 13 of the photomask 14, a plurality of liquid-crystal regions respectively having different alignment states of liquid crystal can be formed even in one liquid-crystal area corresponding to one electrode. Therefore, the region of corresponding to one electrode has a plurality of voltage-transmittivity (diffraction index) characteristics. That is, a partitioned alignment cell including a plurality of regions of different alignment can be produced. In a plurality of regions, alignment of liquid crystal of each region can be independently changed. Therefore, the alignment of each of the respective regions corresponding to one electrode can be changed at a time. Moreover, the aperture ratio can be increased. In the production of a liquid-crystal lens and a liquid-crystal optical head, it is not necessary to classify the electrodes into a plurality of electrode groups to apply different voltages to liquid crystal.

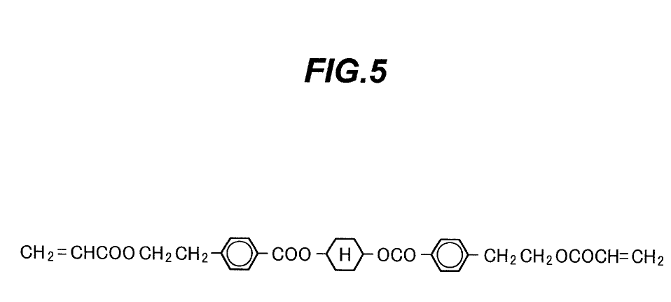

In the embodiments, although ultraviolet-ray-setting monomer is used, ultraviolet-ray-curable liquid crystal may also be used as an additive to obtain a similar advantageous result. As the ultraviolet-ray-curable liquid crystal, a mesomorphic di-acrylate monomeric resin (FIG. 5) may be employed.

In the embodiments, the liquid-crystal cell desirably has a thickness ranging from 0.5 μm to 100 μm, and more preferably from 1 μm to 8 μm, and still more preferably ranging from 2 μm to 6 μm. When the liquid-crystal optical controller is used as a liquid-crystal lens, the polarization plates and the phase compensation plate are not required. In place thereof, a quarter-wavelength plate is required depending on cases.

It is advantageous that black is easily displayed (compensated) when anisotropy Δε of relative dielectric constant of liquid crystal of the cell is positive. This is favorable for a liquid crystal shutter. However, for a liquid-crystal lens, it is advantageous to increase the difference in the refractive index, and hence Δε may be positive or negative.

The pixel division may be entirely carried out in the liquid-crystal lens by a photomask in the polymerization and stabilization stage. However, to increase degree of freedom of characteristics of the lens, the ITO patterning on the electrode side may be partially used. In this case, naturally, the number of pixels can be remarkably decreased as compared with the prior art.

The embodiments lead to advantages as follows.

(1) A high-speed response can be obtained when the cell thickness is about 4 μm. Therefore, the liquid-crystal cell can be produced with high production yield even without using a high-quality clean room of a high clean level.

(2) When the liquid crystal in the liquid crystal layer can be polymerized to a particular density, the rising speed can be increased. This increases degree of freedom to select liquid-crystal materials.

(3) To achieve a function of a liquid-crystal lens, the electrode division for a plurality of electrodes is not required or the number of divisions can be remarkably reduced. This improves production yield. By minimizing the number of divisions, the ineffective area can be reduced. This leads to improvement of the aperture ratio and makes it possible to increase the quantity of light to be used. Resolution of the electrode division can be remarkably increased. For example, the resolution is limited to 10 μm in the prior art. In the embodiments, a pixel resolution of 0.5 μm to 3 μm is possible. In the prior art, light utilization efficiency is lowered to about 50% for the resolution of 10 μm. In the embodiments, high efficiency of light utilization is kept unchanged even for the resolution of 0.5 μm to 3 μm.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

TABLE 1

| | OVERALL DRIVING | | INTERMEDIATE-GRADATION DRIVING | | | |
|---|---|---|---|---|---|---|
| | RISE | FALL | RISE | FALL | RISE | FALL |
| | OVERALL | OVERALL | GRADATION | GRADATION | GRADATION | GRADATION |
| | OFF → ON | ON → OFF | 0 → 1 | 1 → 0 | 6 → 7 | 7 → 6 |
| | 0.3 V →2.2 V | 2.2 V → 0.3 V | 0.3 V → 0.6 V | 0.6 V → 0.3 V | 1.8 V → 2.2 V | 2.2 V → 1.8 V |
| HAN-TYPE CELL | 1.1 mS | 3.1 ms | 2.7 ms | 2.9 ms | 1.2 ms | 1.5 ms |
| WITHOUT | | | | | | |
| POLYMERIZATION | | | | | | |
| HAN-TYPE CELL | 1.2 ms | 1.5 ms | 2.5 ms | 1.5 ms | 1.3 ms | 1.0 ms |
| WITH | | | | | | |
| POLYMERIZATION | | | | | | |
| TN-TYPE CELL | 0 V → 20 V | 20 V → 0 V | 1.4 V → 1.6 V | 1.6 V → 1.4 V | 2.4 V → 2.8 V | 2.8 V → 2.4 V |
| | 0.3 ms | 1.8 ms | 13.2 ms | 9.1 ms | 1.5 ms | 2.0 ms |

What is claimed is:

1. A liquid-crystal optical controller, comprising:
a first substrate;
a first electrode formed on one surface of said first substrate;
a first alignment film formed on said first substrate to cover said first electrode, the first alignment film having an alignment characteristic of a horizontal or vertical alignment film;
a second substrate formed opposing to said first substrate with a predetermined gap therebetween;
a second electrode formed on a surface of said second substrate, the surface opposing to said one surface of said first substrate;
a second alignment film formed on said second substrate to cover said first electrode, the film having an alignment characteristic opposite to that of said first alignment film; and
a large number of liquid-crystal molecules and polymer mixed with the liquid-crystal molecules for stabilizing a state of chemical bonds between said liquid-crystal molecules,
said liquid-crystal molecules and said polymer forming a liquid-crystal layer sandwiched between said first substrate and said second substrate, wherein
said liquid-crystal layer includes a plurality of regions respectively having different states of chemical bonds between said liquid-crystal molecules.

2. A liquid-crystal optical controller according to claim 1, wherein said polymer has different degrees of polymerization in the regions.

3. A liquid-crystal optical controller according to claim 1, wherein said polymer is a polymer of a ultraviolet-ray-setting monomer.

4. A liquid-crystal optical controller according to claim 1, wherein said polymer is a polymer of a ultraviolet-ray-curable liquid crystal.

5. A liquid-crystal optical controller according to claim 4, wherein said ultraviolet-ray-curable liquid crystal is a mesomorphic di-acrylate monomer.

6. A liquid-crystal optical controller according to claim 1, wherein said first substrate and said first electrodes are transparent.

7. A liquid-crystal optical controller according to claim 1, wherein said second electrode includes a plurality of electrodes respectively disposed in said regions.

8. A liquid-crystal optical controller according to claim 1, wherein said second electrode is formed in an area including at least two of the regions.

9. A liquid-crystal optical controller according to claim 1, wherein said first substrate is apart from said second substrate by a distance of 1 μm to 8 μm.

10. A liquid-crystal optical controller according to claim 1, wherein said first substrate is apart from said second substrate by a distance of 2 μm to 6 μm.

11. A liquid-crystal optical controller according to claim 1, further comprising a first polarization plate on an outside of said first substrate and a second polarization plate on an outside of said second substrate, said first polarization plate having a polarization axis orthogonal to a polarization axis of said second polarization plate.

12. A liquid-crystal optical controller according to claim 11, further comprising a phase compensation plate between said first substrate and said first polarization plate or between said second substrate and said second polarization plate.

13. A method of producing a liquid-crystal optical controller, comprising the steps of:
forming electrodes on one surface of a first substrate;
forming electrodes on one surface of a second substrate, said second substrate opposing to said first substrate;
preparing a phase boundary of the first substrate, the phase boundary allowing liquid-crystal molecules to align parallel to said substrate;
preparing a phase boundary of the second substrate, the phase boundary allowing liquid-crystal molecules to align vertical to said substrate;
filling a gap between said first and second substrates with liquid crystal to which a polymerizable material is added; and
polymerizing the material added to the liquid crystal.

14. A method of producing a liquid-crystal optical controller according to claim 13, the step of polymerization includes the step of irradiating a ultraviolet ray to the liquid crystal while applying predetermined voltages to said electrodes of said first and second substrates.

15. A method of producing a liquid-crystal optical controller according to claim 14, comprising the step of irradiating the ultraviolet ray through a photomask having a predetermined opening pattern.

16. A method of producing a liquid-crystal optical controller according to claim 13, wherein the polymerizable material is a ultraviolet-ray-setting monomer.

17. A method of producing a liquid-crystal optical controller according to claim 13, wherein the polymerizable material is a ultraviolet-ray-curable liquid crystal.

18. A method of producing a liquid-crystal optical controller according to claim 13, wherein said first substrate is apart from said second substrate by a distance of 1 μm to 8 μm.

19. A method of producing a liquid-crystal optical controller according to claim 13, wherein said first substrate is apart from said second substrate by a distance of 2 μm to 6 μm.

20. A method of producing a liquid-crystal optical controller according to claim 11, wherein a content of the polymerizable material in the liquid crystal ranges from 0.5 wt % to 2 wt %.
